(19) United States
(12) Patent Application Publication
(10) Pub. No.: US 2006/0282590 A1
(43) Pub. Date: Dec. 14, 2006

(54) IMAGE FORMING DEVICE

(75) Inventors: Sachiko Yoshimura, Osaka (JP); Takanori Miyamoto, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/420,475

(22) Filed: May 26, 2006

(30) Foreign Application Priority Data
May 27, 2005 (JP) 2005-155688

(51) Int. Cl. G06F 13/24

(52) U.S. Cl. 710/260

(57) ABSTRACT

An image forming device having enhanced usability when a resource thereof is being exclusively used is disclosed. The image forming device allows a resource thereof to be exclusively used by a user, and comprises an reservation unit and an interrupt processing unit. The reservation unit is configured to reserve a specific resource for exclusive use if a request having required information attached therewith is received thereby. The interrupt processing unit is configured to send a rejection having certain information about the exclusive usage of a requested resource attached thereto to the user who requested an interrupt request, as a response to the interrupt request, when the specific resource being requested is being exclusively used by another user.

### CROSS-REFERENCE TO RELATED APPLICATIONS

This application claims priority to Japanese Patent Application No. 2005-155688. The entire disclosure of Japanese Patent Application No. 2005-155688 is hereby incorporated herein by reference.

### BACKGROUND OF THE INVENTION

1. Field of the Invention

The present invention relates to an image forming device. More specifically, the present invention relates to an image forming device having improved usability while being operated.

2. Background Information

Recently, an image forming device such as a multifunction device functioning as a printer and a copying machine has been widely used. This type of image forming device is generally used by a plurality of users, and thus there have been problems with the way the various functions and elements of this type of device are shared.

For example, when a user wants to perform printing with a special type of paper, the required number of sheets of the special paper are placed onto a feeding tray of an image forming device, and then a print request will be transmitted to the image forming device from a host device (e.g., a computer).

However, if the special type of paper is set on the feeding tray first and then a different print request is sent from a different user before the user who has set the special paper on the tray is able to send a print request, the special paper could be mistakenly used for a different print request.

Therefore, Japan Patent Application Publication JP-A-2004-109526 discloses an image forming device 100, shown in FIG. 4, in which a user is allowed to instruct the device that the feeding tray will be exclusively used, and at the same time enter an authentication password unknown to other users from an operation unit 101.

A control unit 110 will then lock the feeding tray based on the instruction, and thus usage of the paper on the feeding tray by others will be prohibited until a predetermined reservation period has elapsed or until the authentication password is reentered. Note that hereinafter feeding tray(s) may be referred to as resource(s).

A user can reserve the use of a specific resource in the image forming device with the above described conventional technology. However, this will also prevent other users from using the same resource while that resource is being exclusively used by a user. In addition, it is impossible for other users to find out why they cannot use that resource, how long that resource will be exclusively used, and information about the user who is exclusively using the resource. Therefore, the usability of the above described image forming device will be poor when a resource thereof is exclusively used by a user.

In view of the above, it will be apparent to those skilled in the art from this disclosure that there exists a need for an improved image forming device having improved usability, particularly when an interrupt request is received in which the resource specified thereby is the same resource that is being exclusively used by a different user. This invention addresses this need in the art as well as other needs, which will become apparent to those skilled in the art from this disclosure.

### SUMMARY OF THE INVENTION

In accordance with a first aspect of the present invention, an image forming device is disclosed that is capable of allowing a specific resource thereof to be exclusively used by a user. The image informing device is comprised of an reservation unit and an interrupt processing unit. The reservation unit is configured to reserve a specific resource for exclusive use if a request to reserve that resource is received with required information attached thereto. The interrupt processing unit will inform the source of an interrupt request that the interrupt request has been rejected when the specific resource is being exclusively used, and will provide the required information attached to the request for reservation to the source of the interrupt request.

Therefore, it is possible to improve usability of the image forming device when a specific resource is being exclusively used.

In accordance with a second aspect of the present invention, in the image forming device according to the first aspect of the present invention, the interrupt processing unit can receive another request from the source of the interrupt request and process the received request after informing the source of the interrupt request that the interrupt request has been rejected.

According to the second aspect of the present invention, the user who requested the interrupt request can make a different request when the interrupt request is rejected. Therefore, usability of the image forming device can be further enhanced when a specific resource is exclusively used by a user.

In accordance with a third aspect of the present invention, in the image forming device according to the first aspect of the present invention, the required information includes information such as the reason for the reservation, the amount of time that the resource will be reserved, and information about the user who will be exclusively using the resource.

In accordance with a fourth aspect of the present invention, in the image forming device according to the second aspect of the present invention, the new request can be one selected from the group consisting of a request to cancel the interrupt request, a request to use the specific resource after the specific resource is released from exclusive usage by a user, a request to change the interrupt request, a request to query the user who is exclusively using the specific resource, and a request to release the specific resource from being exclusively used by a user.

In accordance with a fifth aspect of the present invention, in the image forming device according to the fourth aspect of the present invention, if the new request selected is a request to release the resource from being exclusively used by a user, the interrupt processing unit will perform password authentication with respect to an externally received password. Furthermore, if the externally received password is authenticated, the interrupt processing unit will allow the specific resource to be released from being exclusively used by a user.

As described above, in the image forming device in accordance with the present invention, if an interrupt request is submitted to the image forming device while the resource specified in the interrupt request is being exclusively used by a different user, the user who requested the interrupt request will receive certain information about the exclusive usage. Therefore, it is possible to enhance usability of the image forming device when a specific resource is being exclusively used by a user.

In addition, in the image forming device of the present invention, when an interrupt request is rejected, the user who requested the interrupt request is capable of making a new request. Therefore, it is possible to further enhance usability of the image forming device when a specific resource is being exclusively used by a user.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic functional block diagram showing the configuration of an image forming device in accordance with one embodiment of the present invention;

FIG. 2 is a flow chart showing the operation of the image forming device in accordance with one embodiment of the present invention;

FIG. 3 shows a screen in which an interruption request is being rejected; and

FIG. 4 is a block diagram showing the configuration of a conventional image forming device.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

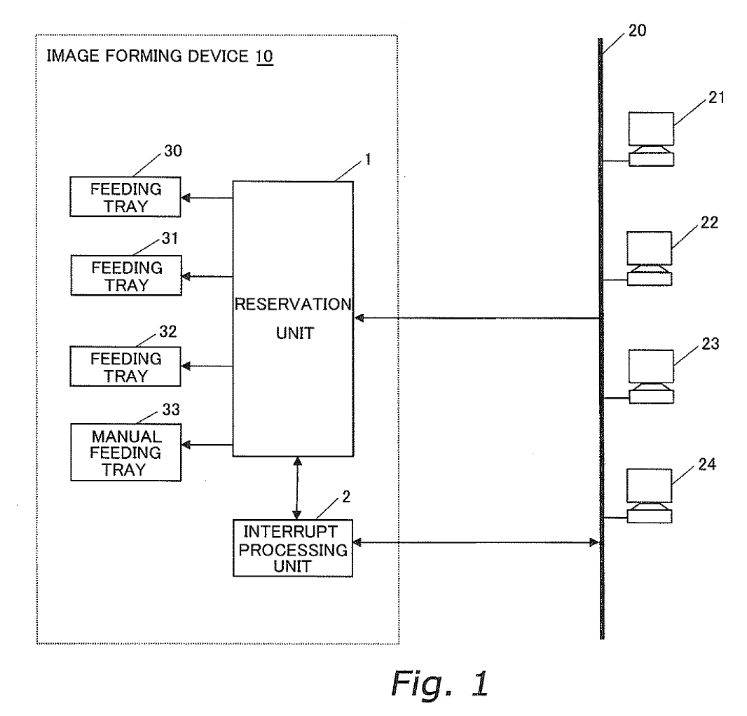

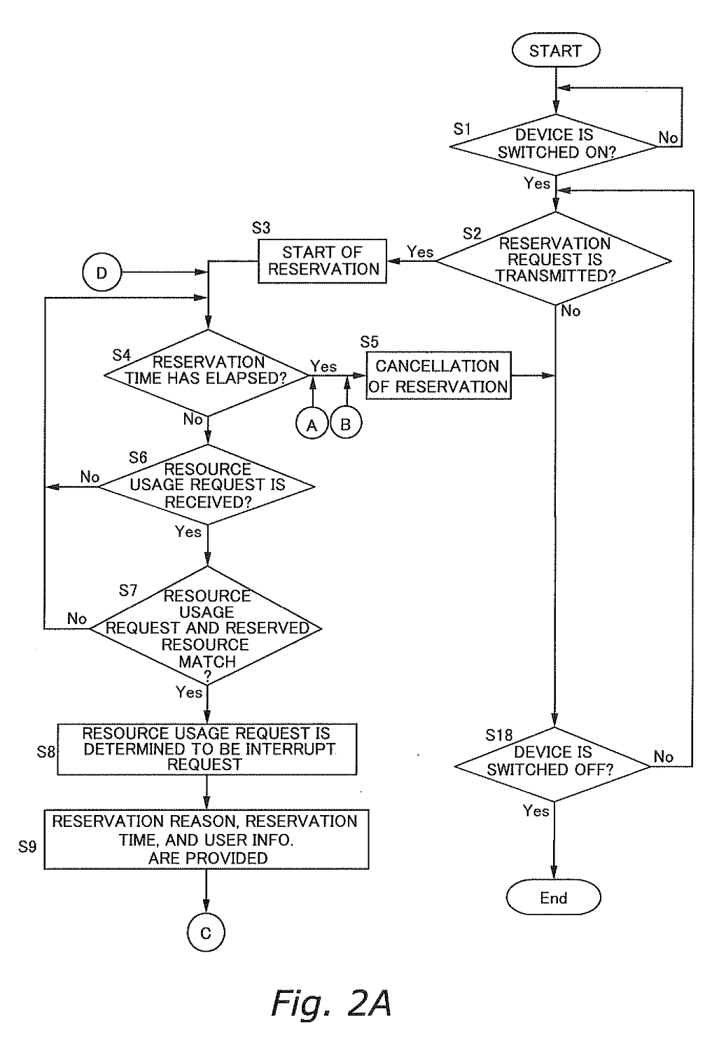

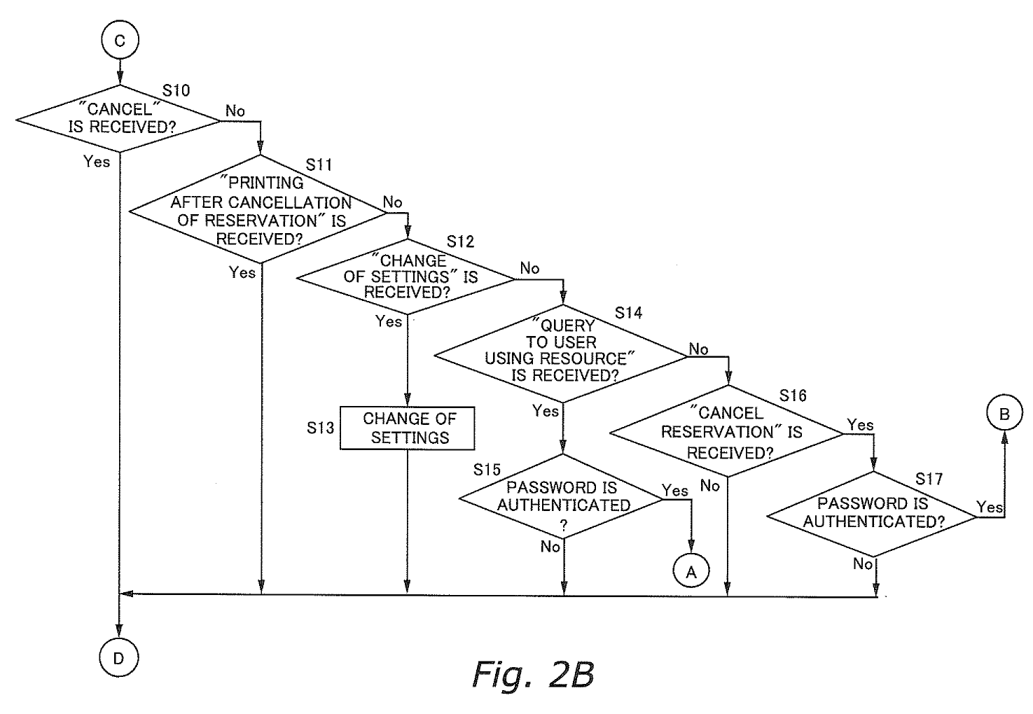

FIG. 1 is a schematic functional block diagram of an image forming device 10 in accordance with one embodiment of the present invention. In addition, FIG. 2 is a flow chart showing the operation of the image forming device 10 in accordance with one embodiment of the present invention.

The image forming device 10 is assumed to be connected to host devices PC 21, PC 22, PC 23, and PC 24 through a local area network (LAN) 20.

As shown in FIG. 2, when a user switches on the image forming device 10 (step S1), and the user wants to perform printing using a special type of paper, a request can be made to reserve a specific resource on the image forming device 10. In this embodiment, for example, the resources which a user can reserve are a feeding tray 30, a feeding tray 31, a feeding tray 32, and a manual feeding tray 33.

situation in which a user operating the host device PC 21 transmits a request to reserve the manual feeding tray 33 will be described in detail below.

If a “reservation” button displayed on the operation screen of the host device PC 21 is clicked by the user, a reservation setting screen will be displayed thereon. The resource to be reserved, the reason therefor, the amount of time the resource will be reserved, and user information will entered in the reservation setting screen by the user in order to request a reservation for a resource. Here, the user information includes a user name, a user ID, a user password, and the like.

The reason for reservation, and the amount of time that the resource will be reserved, may be manually input. However, entry of these items is not limited to manual input. For example, the reason for reservation may be entered by being chosen from a pull-down menu comprised of a plurality of predetermined options, and the amount of time that the resource will be reserved may be entered by being chosen from a pull-down menu comprised of a plurality of time periods.

Thus, the host device PC 21 will notify the reservation unit 1 of the image forming device 10 that a request to reserve the manual feeding tray 33 has been made by a user (step S2). The reservation unit 1 will store data concerning the resource to be reserved, the reason therefor, the amount of time that the resource will be reserved, and the user information. The reservation unit 1 will then lock the manual feeding tray 33 to thereby reserve the manual feeding tray 33 (step S3) and begin the reservation period.

Once the manual feeding tray 33 is in a reserved state, other users will be largely unable to use the manual feeding tray 33 until the reservation time period has elapsed (step S4) and the reserved state thereof is canceled (step S5).

Therefore, the user who submitted the request to reserve the manual feeding tray 33 can perform printing without worrying whether the special type of paper placed in the manual feeding tray 33 will by used by other users.

On the other hand, when another user wants to use the manual feeding tray 33 while it is being exclusively used by someone else, a request to use the reserved manual feeding tray 33 may be submitted to the image forming device 10. This request is referred to as a resource usage request. However, until such a resource usage request is received, the reservation unit 1 of the image forming device 10 will continue to allow the manual feeing tray 33 to be exclusively used by a user (from step S6 to step S4).

A situation in which a user operating the host device PC 22 performs a resource usage request for the reserved manual feeding tray 33 will be described in detail below. Specifically, the resource usage request will be performed when the other user notifies the reservation unit 1 of the resource usage request, for instance, via the operation screen displayed on the host device PC 22.

First, when the reservation unit 1 receives a resource usage request, the reservation unit 1 will refer to the stored information about the resource that is currently being exclusively used by a user, and determine if the resource specified by the resource usage request matches the resource that is currently being exclusively used by a user (from step S6 to step S7). In other words, the reservation unit 1 will determine whether or not the feeding tray specified in the resource usage request is being exclusively used by another user.

If the resource that is being exclusively used, in this case the manual feeding tray 33, and the resource specified in the resource usage request do not match in step S7, the reservation unit 1 will continue to allow the manual feeding tray 33 to be exclusively used (from step S7 to step S4). On the other hand, if the resource specified in the resource usage request matches the resource that is being exclusively used, the reservation unit 1 will handle the resource usage request as an interrupt request (step S8). Note that an interrupt request refers to, for example, a request to use a resource by a user, in a situation in which a different user is already exclusively using the same resource.

Here, the resource being requested is the same resource that is being exclusively used. A situation in which a resource usage request is handled as an interrupt request to use the manual feeding tray 33 is described below.

As described above, if the reservation unit 1 receives an interrupt request, the reservation unit 1 will notify the interrupt processing unit 2. After being notified, the interrupt processing unit 2 reads out the data on the reason for the reservation, the amount of time that the resource will be reserved, and the user information which are stored in the reservation unit 1.

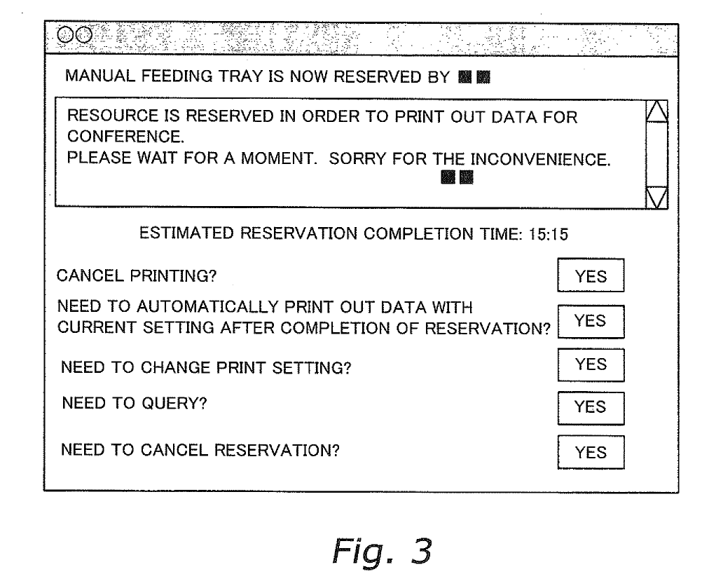

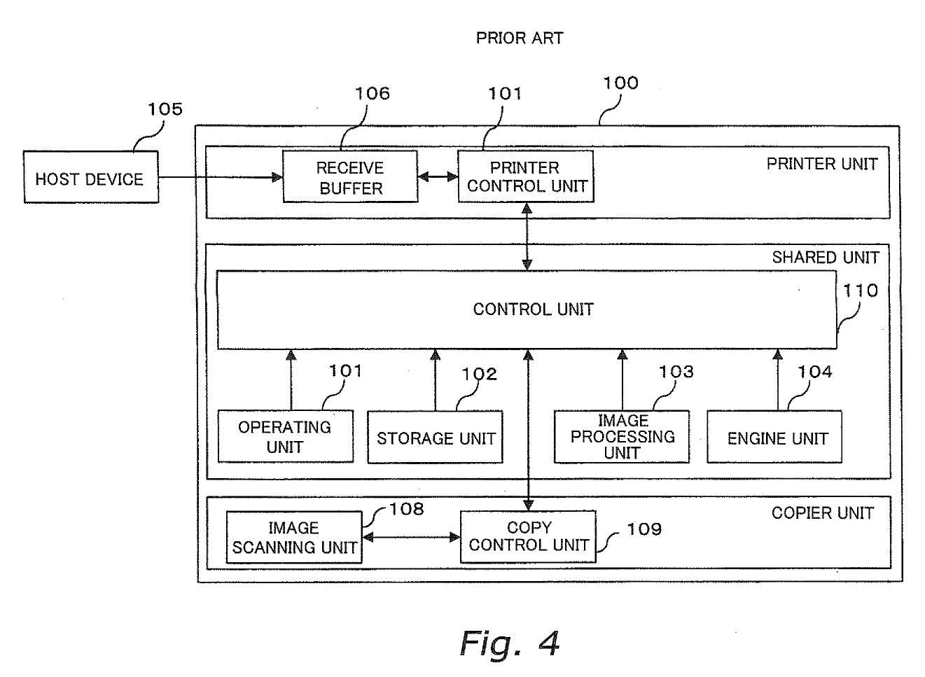

After reading out the data, the interrupt processing unit 2 will send a rejection of the interrupt request to the host device PC 22 which transmitted the interrupt request (step S9). Data on the reason for the reservation, the amount of time that the resource will be exclusively used, and the user information read out by the interrupt processing unit 2 is attached to the rejection. The host device PC 22 then displays the rejection of the interrupt request received from the image forming device 10 on the operation screen thereof, as shown in FIG. 3.

Here, after the interrupt processing unit 2 sends the rejection to the host device PC 22 that includes data on the reason for the reservation, the amount of time that the resource will be reserved, and the user information, the user of the host device PC 22 can choose from options shown on the screen, such as to cancel the printing request, to print after the specified resource is no longer being exclusively used, to change the settings of the printing request, to query the user that is exclusively using the resource, or to release the resource from exclusive use. A selection made here by the user of the host device PC 22 will be sent to the interrupt processing unit 2 as a new request.

If the interrupt processing unit 2 receives a request to cancel the printing request, the interrupt processing unit 2 will cancel the interrupt request, and instruct the reservation unit 1 to continue to allow the manual feeding tray 33 to be exclusively used by the user of the host device PC 21 (from step S10 to step S4). In addition, if the interrupt processing unit 2 receives a request to print after the specified feeding tray is no longer being exclusively used, the interrupt processing unit 2 will instruct the reservation unit 1 to continue to allow the manual feeding tray 33 to be exclusively used, and the printing request will be performed after the reserved time period has elapsed (step S11, step S4, and step S5).

Furthermore, if the interrupt processing unit 2 receives a request to change the settings of the printing request, the reservation unit 1 will continue to allow the manual feeding tray 33 to be exclusively used, and the interrupt processing unit 2 will allow the user to specify a different feeding tray. Printing will be performed using the newly specified feeding tray (from steps S12 and S13 to step S4).

When the interrupt processing unit 2 receives a request to query the user exclusively using the resource, and as a result of the query, the user exclusively using the resource, in this case the user of the host device PC 21, agrees to release the resource from exclusive use, the interrupt processing unit 2 will perform an authentication by having the user of the host device PC 21 enter his or her password therefrom. If the password of the user is authenticated, the interrupt processing unit 2 will instruct the reservation unit 1 to release the manual feeding tray 33 from being exclusively used by the user of the host device PC 21 (from steps S 14 and S 15 to step S5). On the other hand, if the password is not authenticated, the interrupt processing unit 2 will instruct the reservation unit 1 to continue to allow the manual feeding tray 33 to be exclusively used by the user of the host device PC 21 (from steps S14 and S15 to step S4).

Furthermore, when the interrupt processing unit 2 receives a request to query the user exclusively using the resource, and as a result of the query, the user exclusively using the resource does not agree to release the resource from exclusive use, the reservation unit 1 will continue to allow the manual feeding tray 33 to be exclusively used.

If the user who requested the interrupt request (i.e., the user of the host device PC 22) is, for example, an administrator of the image forming device 10, and if the interrupt processing unit 2 receives a request to release the resource from exclusively use from the user of the host device PC 22, the interrupt processing unit 2 will perform an authentication by having the administrator enter his or her password via the host device PC 22. If the administrator's password is authenticated, the interrupt processing unit 2 will instruct the reservation unit 1 to release the manual feeding tray 33 from exclusive usage (from steps S16 and S17 to step S5). On the other hand, if the administrator's password is not authenticated, the interrupt processing unit 2 will instruct the reservation unit 1 to continue to allow the manual feeding tray 33 to be exclusively used by the user of the host device PC 21 (from steps S16 and S17 to step S4).

If the reservation unit 1 receives a request from a user to exclusively use a resource, the above described series of steps will be performed, and the resource will be allowed to be exclusively used by this user until the resource is released from being exclusively used by this user. In addition, if a request to exclusively use a resource is not received in step S2, or if an exclusively used resource is released from exclusive use, the resource will remain in a standby state until the image forming device is shut down (step S18).

According to the present embodiment of the present invention, if an interrupt request is submitted to the image forming device 10 in order to use a specific resource, and the same resource is being exclusively used by a different user, the user who requested the interrupt request will be provided with certain information about the usage. Therefore, it is possible to enhance the usability of the image forming device while a resource is being used.

In addition, according to the present embodiment of the present invention, if an interrupt request is rejected, the user who requested the interrupt request will be able to make a different request. Therefore, it is possible to further enhance the usability of the image forming device while a resource is being used.

Here, through the operation screen of either the host device PC 21 or PC 22, a user is able to issue an instruction or make a request, and in response to the request, receive a response thereto. However, the present invention is not limited to this example. For instance, a user may both request and receive responses through any of the operation screens of the host devices PC 23 and PC 24 and the image forming device 10.

Furthermore, a situation in which printing using a special type of paper is described above. Therefore, the manual feeding tray 33 is selected to be the resource that is exclusively used by a user as an example. However, the resource that can be exclusively used by a user is not limited to this specific resource. In addition, the task requested by a user is not limited to printing. For example, the task requested could be a copy request.

As described above, in an image forming device according to one embodiment of the present invention, if an interrupt request to use a specific resource is submitted while this same resource is being exclusively used by a different user, the user who requested the interrupt request will be provided with certain information about the usage thereof. Therefore, the image forming device in accordance with one embodiment of the present invention will have an enhanced usability while a specific resource is being exclusively used.

### GENERAL INTERPRETATION OF TERMS

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An image forming device in which a resource thereof can be exclusively used by a user, comprising:
an reservation unit configured to reserve the resource for exclusive use by a first user when a request to reserve the resource for exclusive use is received thereby and required information is attached to the request; and
an interrupt processing unit configured to notify a second user who transmitted an interrupt request to use the resource that the interrupt request is rejected when the resource is being exclusively used by the first user, and provide the required information attached to the request to reserve the resource to the second user together with the notification of rejection.

2. The image forming device according to claim 1, wherein the interrupt processing unit is configured to accept a new request from the second user, and perform the newly received request, when the second user is notified of the rejection of the interrupt request.

3. The image forming device according to claim 1, wherein the required information comprises a reason for reserving the resource, an amount of time that the resource will be exclusively used, and information on the user requesting exclusive usage of the resource.

4. The image forming device according to claim 2, wherein the new request is one selected from the group consisting of a request to cancel the interrupt request, a request to use the resource after the resource is released from exclusive usage, a request to change the interrupt request, a request to query the first user who is exclusively using the resource, and a request to release the resource from exclusively usage.

5. The image forming device according to claim 4,
wherein the interrupt processing unit is configured to perform a password authentication with respect to an externally received password if the new request is a request to release the resource from exclusive usage, and configured to allow the resource to be released from exclusively usage when the externally received password is authenticated.
